(19) United States
(12) Patent Application Publication
(10) Pub. No.: US 2007/0281178 A1
(43) Pub. Date: Dec. 6, 2007

(54) PDP filter having multi-layer thin film and method of manufacturing the same

(75) Inventors: Jeong Hong Oh, Gumi-si (KR); Je Choon Ryoo, Dalseo-gu (KR); Jang Hoon Lee, Gumi-si (KR)

Correspondence Address: MCDERMOTT WILL & EMERY LLP, 600 13TH STREET, N.W., WASHINGTON, DC, 20005-3096, US

(73) Assignee: SAMSUNG CORNING CO., LTD

(21) Appl. No.: 11/634,871

(22) Filed: Dec. 7, 2006

(30) Foreign Application Priority Data
May 30, 2006 (KR) 10-2006-0048495

(51) Int. Cl. B32B 17/06; B32B 15/04

(52) U.S. Cl. 428/469; 428/432; 428/433

(57) ABSTRACT

A plasma display panel (PDP) filter having a multi-layer thin film, the PDP filter including: a transparent substrate; at least one repeating unit layer comprising a high refractive transparent thin film layer, a metal oxide film layer, and a metal thin film layer located on the transparent substrate, and stacking each repeating unit layer; and the high refractive transparent thin film layer being formed on a upper portion of the at least one repeating unit layer.

### CROSS-REFERENCE TO RELATED APPLICATION

This application claims the benefit of Korean Patent Application No. 10-2006-0048495, filed on May 30, 2006, in the Korean Intellectual Property Office, the disclosure of which is incorporated herein by reference.

### BACKGROUND OF THE INVENTION

1. Field of the Invention

The present invention relates to a plasma display panel (PDP) filter and a method of manufacturing the same, and more particularly, to a PDP filter having a multi-layer thin film which has a high refractive index and light transmittance, and may increase productivity of production facilities.

2. Description of Related Art

Generally, in a plasma display panel (PDP) device, neon+argon (Ne+Ar) gas, neon+xenon (Ne+Xe) gas, and the like are contained in a space which is covered by a front glass plate, a rear glass plate, and a partition glass plate. In this instance, a voltage is applied to an anode electrode and a cathode electrode, and a fluorescent light which is used as a backlight is emitted.

The PDP device is generally operated by a successive pulse having a regular voltage. Also, the PDP device is operated by amplifying an image signal, since a relatively high voltage, for example, hundreds of volts, is required for a gas discharge. Properties of the gas discharge which facilitate a display device's large size may be applicable to an operation method of the PDP device. Accordingly, the PDP device is suitable for a large size display device. In the PDP device, the gas discharge occurs due to a direct current (DC) or alternating current (AC) voltage which is applied to the electrodes. In this instance, ultraviolet (UV) rays are emitted, and thereby excite phosphors to emit visible light. However, when the PDP device operates, a great amount of glare of the phosphors, electromagnetic waves, and near infrared rays are emitted. Also, an orange light emitted from helium (He) and xenon (Xe) is generated. Accordingly, color purity of the PDP device is inferior to the color purity of a cathode ray tube (CRT).

Thus, in order to overcome the disadvantages described above, a PDP filter which may shield the electromagnetic waves and near infrared rays, prevent the glare, and/or improve the color purity is used in the PDP device. Also, the PDP filter is required to have a satisfactory transparency, since the PDP filter is mounted on a front portion of a panel assembly. An electric current flowing between a driving circuit and an AC electrode, and a high voltage between electrodes used for plasma discharge are the main causes of electromagnetic waves. The electromagnetic waves generated by such causes are mainly in the frequency band of 30-200 MHz. Generally, a transparent conductive film or a conductive mesh that maintains a high light transmittance and a low refractive index in a visible light spectrum is used as an electromagnetic shielding layer for shielding the generated electromagnetic waves.

FIG. 1 is a cross-sectional view illustrating a PDP filter according to a conventional art.

Referring to FIG. 1, the PDP filter according to the conventional art includes two low reflective films 110, a transparent substrate 120, and a coating layer 130. Generally, one side of the low reflective films 110 is processed by a low reflection coating, and another side of the low reflective films 110 is applied with an adhesive material to easily bond the low reflective film 110 with the transparent substrate 120. Accordingly, in FIG. 1, an outer side of the low reflective films 110 is processed by the low reflection coating, and an inner side of the low reflective films 110 which faces towards the transparent substrate 120 is applied with the adhesive material, respectively. Also, when necessary, a pigment may be added for color correction on one side of the low reflective films 110. The transparent substrate 120 is a substrate having a light transmittance greater than a predetermined value, and is generally composed of a transparent glass. Also, the coating layer 130 is formed on one side of the transparent substrate 120, i.e. one side facing towards a front portion of a PDP module, as shown in FIG. 1. The coating layer 130 has a multi-layer thin film structure which enables a PDP filter to shield an electromagnetic wave and have a satisfactory light transmittance. Accordingly, properties of the PDP filter may be determined depending on a structure and a component of the multi-layer thin film.

Generally, the PDP filter may be classified into two product categories, i.e. a product category which requires a sheet resistance to be less than approximately 1.5 Ω/sq, and another product category which requires a sheet resistance to be less than approximately 2.5 Ω/sq. According to a safety standard which is currently required for all countries, a class A corresponds to the product range having the sheet resistance of less than approximately 2.5 Ω/sq, and a class B corresponds to the product category having the sheet resistance of less than approximately 1.5 Ω/sq. Also, the component included in the multi-layer thin film and a number of layers vary according to each of the product categories. The product category B having the sheet resistance of less than approximately 1.5 Ω/sq has a lower light transmittance and a higher reflectance than the product category A having the sheet resistance of less than approximately 2.5 Ω/sq. In association with this, in the PDP filter which is at present most widely used, when the PDP filter has the sheet resistance of less than approximately 1.5 Ω/sq, the PDP filter has a 4-Ag structure where four Ag layers are inserted. When the PDP filter has the sheet resistance of less than approximately 2.5 Ω/sq, the PDP filter has a 3-Ag structure where three Ag layers are inserted.

FIG. 2 is a diagram illustrating a multi-layer thin film having a 4-Ag structure according to the conventional art. Referring to FIG. 2, a first oxide film 220, a second oxide film 230, and silver (Ag) 240 are stacked on a transparent substrate 210. Also, in order to prevent the Ag 240 from being oxidized by the first oxide film 220, another second oxide film 250 is stacked on the Ag 240. Such structure is stacked four times, thereby forming the multi-layer thin film having the 4-Ag structure.

In the multi-layer thin film described above, a plurality of second oxide films 250 is required to be stacked. Accordingly, coating facilities required, production cost, and production time increase, and thus productivity may decrease.

Also, when another first oxide film 260, which may be a high refractive layer, is coated on the Ag 240 using a reactive deposition method, conductivity and light transmittance of the Ag 240 may be reduced. Accordingly, to prevent such transformation, the other second oxide film 250 or the other first oxide film 260 is selectively coated on the Ag 240. In this instance, the other first oxide film 260 does not require a reactive coating. Also, a refractive index of the first oxide film 260 is optically low, which may affect an overall physical characteristic of a PDP filter.

Also, a unit cost of indium (In), which is a raw material of an indium tin oxide (ITO), is high. The ITO is widely used as the other second oxide film 250.

### BRIEF SUMMARY

The present invention provides a conductive film filter which is located on a silver (Ag) thin film and does not suffer degradation in conductivity, and a conductive material of a PDP filter without requiring an additional oxide protection layer.

The present invention also provides a PDP filter having a multi-layer thin film and a method of manufacturing the same which may reduce a target cost for a deposition of a conventional second oxide film without a reduction in conductivity, and retard a degradation process of the conventional second oxide film.

The present invention also provides a PDP filter having a simple-structured multi-layer thin film which may improve a refractive index and light transmittance of the PDP filter.

The present invention also provides a coating method without requiring a great amount of added oxygen which may increase productivity of a coating facility.

The present invention also provides a PDP filter having a multi-layer thin film which does not require an additional formation of a second oxide film layer.

According to an aspect of the present invention, there is provided a plasma display panel (PDP) filter having a multi-layer thin film, the PDP filter including: a transparent substrate; at least one repeating unit layer comprising a high refractive transparent thin film layer, a metal oxide film layer, and a metal thin film layer, located on the transparent substrate, and stacking each repeating unit layer; and the high refractive transparent thin film layer being formed on a upper portion of the at least one repeating unit layer.

According to another aspect of the present invention, there is provided a method of manufacturing a PDP filter, the method including: stacking at least one repeating unit layer comprising a high refractive transparent thin film layer, a metal oxide film layer, and a metal thin film layer on a transparent substrate; and stacking the high refractive transparent thin film layer on a upper portion of the at least one repeating unit layer.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a cross-sectional view illustrating a PDP filter according to a conventional art;

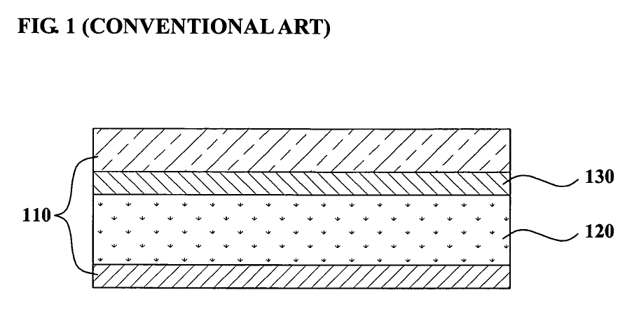

FIG. 2 is a diagram illustrating a multi-layer thin film having a 4-Ag structure according to the conventional art;

FIG. 3 is a diagram illustrating a structure of a multi-layer thin film of a PDP filter according to an embodiment of the present invention;

FIG. 4 is a diagram illustrating a structure of a multi-layer thin film of a PDP filter having a 3-Ag structure according to an embodiment of the present invention; and

FIG. 5 is a diagram illustrating a structure of a multi-layer thin film of a PDP filter having a 4-Ag structure according to another embodiment of the present invention.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

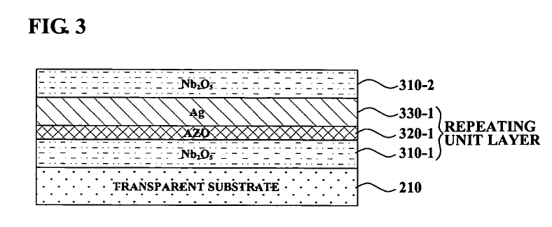

FIG. 3 is a diagram illustrating a structure of a multi-layer thin film of a PDP filter according to an embodiment of the present invention. As shown in FIG. 3, a first Nb₂O₅ layer 310-1, a first aluminum-doped zinc oxide (AZO) layer 320-1, a first Ag layer 330-1, and a second Nb₂O₅ layer 310-2 are sequentially stacked on a transparent substrate 210.

A silver (Ag) target is used, and argon is used as a sputtering gas in the first Ag layer 330-1. In this instance, an amount of the argon used corresponds to approximately 160˜200 sccm. Also, when forming the Nb₂O₅ layers 310-1 and 310-2, the argon is used as the sputtering gas and an oxygen is used as a reactive gas. In this instance, an amount of the argon used may be approximately 140˜210 sccm, and an amount of the oxygen may be approximately 4˜12%, preferably about 8˜12%, of the amount of the argon used. Also, when forming the AZO layer 320-1, the argon is used as the sputtering gas and the oxygen is used as the reactive gas. In this instance, an amount of the argon used may be approximately 160˜200 sccm, and an amount of the oxygen may be approximately 8˜12% of the amount of the argon used. A direct current (DC) sputtering or a mid-frequency (MF) sputtering is available for the Ag layer 330-1, the AZO layer 320-1, and the Nb₂O₅ layers 310-1 and 310-2.

In the multi-layer thin film according to the present invention, a metal thin film layer is formed by silver or an alloy containing the silver. The silver may be effectively used, since the silver has an excellent conductivity, infrared ray reflectance, and light transmittance when multilayered. However, the silver lacks a chemical and physical stability, and is degraded by an environment such as pollutants, vapors, heat, and light. Accordingly, the alloy of the silver and at least one of gold, platinum, palladium, indium, and tin, which are stable, may be favorably utilized. In this instance, a silver content of the alloy may correspond to a value of less than approximately 50-100 wt %, although the silver content of the alloy is not particularly limited. Generally, when adding another metal to the silver, the excellent conductivity and optical characteristics of the silver may be reduced. Accordingly, at least one metal thin film layer of a plurality of metal thin film layers is required not to contain the alloy of the silver and another metal. When an entire metal thin film layer is made up of the silver which is not the alloy, a multi-layer thin film may have excellent conductivity and optical characteristics. However, resilience against the environment may be poor.

Referring to FIG. 3, the first Nb₂O₅ layer 310-1 and the first AZO layer 320-1 are sequentially stacked on the transparent substrate 210. In this instance, the transparent substrate 210 may be a transparent glass. Also, a thickness of the first Nb₂O₅ layer 310-1 may be approximately 25˜33 nm, preferably about 27˜33 nm, and a thickness of the first AZO layer 320-1 may be approximately 3˜7 nm.

In this instance, the transparent substrate 210 is generally manufactured by using a tempered glass or a semi-tempered glass having a thickness of approximately 2.0˜3.5 mm, or a transparent plastic material such as an acrylic. The transparent substrate 210 may preferably have a high transparency and thermal resistance. Also, a high polymer compound and a stacking body of the high polymer compound may be used as the transparent substrate 210. The transparent substrate 210 may preferably have a light transmittance of at least 80% and a glass transition temperature of at least approximately 60° C. The high polymer compound may be transparent in a visible wavelength spectrum. Also, polyethylene terephthalate (PET), polysulfone (PS), polyethersulfone (PES), polystyrene, polyethylene naphthalate, polyarylate, polyether ether ketone (PEEK), polycarbonate (PC), polypropylene (PP), polyimide, a triacetyl cellulose (TAC), and polymethyle methacrylate (PMMA) may be included in the high polymer compound. However, the high polymer compound described above may not be limited to the above-named compounds. The PET is advantageous in terms of a price, a thermal resistance, and a transparency.

In FIG. 3, the first Ag layer 330-1 is coated on the first AZO layer 320-1, and thereby forming a first metal thin film layer. In this instance, a thickness of the first Ag layer 330-1 corresponds to approximately 10˜12 nm. In a conventional art, an indium tin oxide (ITO) layer is used instead of an AZO layer. The ITO has a high light transmittance of approximately 90% at 550 nm in a visible light spectrum, a low electrical resistivity of approximately 2×10⁻⁴ Ωcm, and a high work function. Accordingly, the ITO is widely used as a transparent electrode of a liquid crystal display (LCD), a PDP, and an organic light-emitting diode (OLED). However, despite such optical and electrical characteristic, production costs of indium (In), which is the raw material of the ITO layer, is high. Conversely, a zinc oxide (ZnO) has a high light transmittance in infrared and visible light spectrums, and high durability with respect to an electrical conductivity and a plasma. Accordingly, the ZnO is suitable for manufacturing the transparent substrate which is exposed to a radiation.

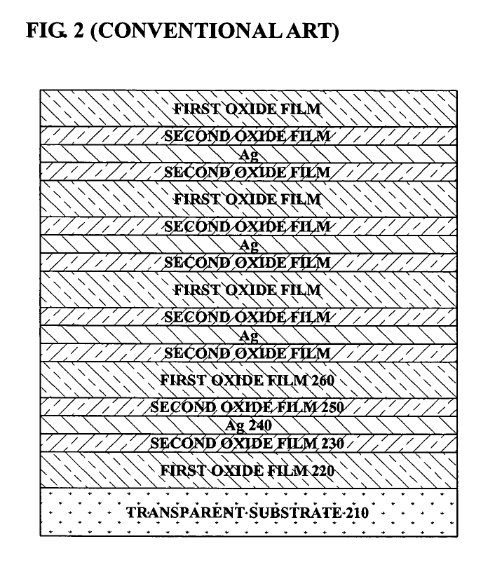

The first Nb₂O₅ layer 310-1, the first AZO layer 320-1, and the first Ag layer 330-1, which are formed through operations described above, form one repeating unit layer. After forming the repeating unit layer, the PDP filter having the multi-layer thin film may be manufactured by stacking a second high refractive transparent thin film layer on a top of the first Ag layer 330-1. According to the conventional art, a second oxide layer 250, i.e. a second ITO layer, is applied prior to the forming of the second high refractive transparent thin film layer, as shown in FIG. 2. In this instance, the second oxide layer 250 functions as a barrier in order to prevent an electrical conductivity of Ag 240 from being degraded due to an oxygen plasma while applying another first Nb₂O₅ layer 260. However, a coating method according to the present invention introduces a target forming the satisfying electrical conductivity. In this instance, the coating method according to the present invention maintains an oxidation condition. Also, the coating method is for a deposition of a high refractive transparent thin film layer, without a need for great amount of added oxygen. Specifically, in an Nb₂O₅ coating film, when the Nb₂O₅ coating film is coated using a target Nb₂Oₓ, where x designates a value from 4.5 to 4.99, an electrical conductivity which can electrically form a cathode is maintained. Accordingly, the Nb₂O₅ coating film may be formed by adding a small amount of oxygen. In this instance, a target Nb₂Oₓ, where x designates a value from 4.8 to 4.99 is preferable. A PDP filter may be manufactured using such target Nb₂Oₓ without additionally forming the second oxide layer according to the conventional art.

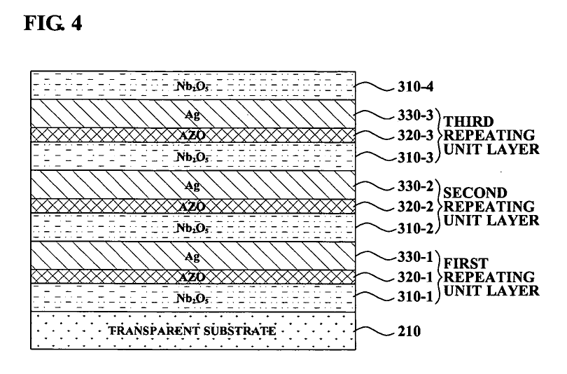

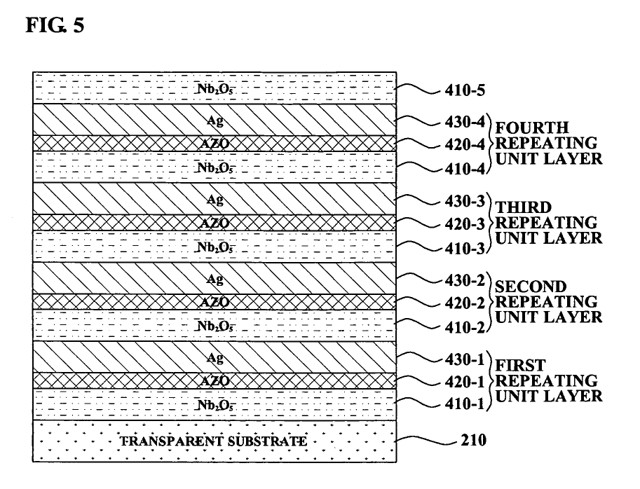

According to an embodiment of the present invention, at least two repeating unit layers described above may be stacked. FIG. 4 illustrates a structure of three repeating unit layers as an example, and FIG. 5 illustrates a structure of four repeating unit layers as an example.

When at least three repeating unit layers are included, a high refractive transparent thin film layer of the repeating unit layer which is the closest to the transparent substrate 210, and a high refractive transparent thin film layer of the repeating unit layer which is the farthest to the transparent substrate 210 have an identical thickness. A thickness of a high refractive transparent thin film layer of the repeating unit layer which is located in the middle of the at least three repeating unit layers is different from the thickness of the high refractive transparent thin film layers having identical thickness. Depending on a number of the repeating unit layer, physical characteristics of the PDP filter may vary, which will be described in detail below.

FIG. 4 is a diagram illustrating a structure of a multi-layer thin film of a PDP filter having a 3-Ag structure according to an embodiment of the present invention. As shown in FIG. 4, a first Nb₂O₅ layer 310-1, a first AZO layer 320-1, a first Ag layer 330-1, a second Nb₂O₅ layer 310-2, a second AZO layer 320-2, a second Ag layer 330-2, a third Nb₂O₅ layer 310-3, a third AZO layer 320-3, a third Ag layer 330-3, and a fourth Nb₂O₅ layer 3104 are sequentially stacked on a transparent substrate 210.

A second repeating unit layer is sequentially stacked on the first Ag layer 330-1 which is described with reference to FIG. 3. Specifically, the second Nb₂O₅ layer 310-2 and the second AZO layer 320-2 are sequentially formed. In this instance, a thickness of the second Nb₂O₅ layer 310-2 may be approximately 24˜33 nm, preferably about 25˜33 nm, and a thickness of the second AZO layer 320-2 may be approximately 3˜7 nm. Also, a thickness of the second Ag layer 330-2 may be approximately 11˜14 nm.

A third repeating unit layer is sequentially stacked on the second repeating unit layer. In this instance, a thickness of the third Nb₂O₅ layer 310-3 may be approximately 25˜33 nm, preferably about 27˜33 nm, and a thickness of the third AZO layer 320-3 may be approximately 3˜7 nm. Also, a thickness of the third Ag layer 330-3 may be approximately 10˜12 nm. Each thickness of the Nb₂O₅ layer and the AZO layer of the third repeating unit layer is identical to each respective thickness of the Nb₂O₅ layer and the AZO layer of the first repeating unit layer.

A PDP filter having the multi-layer thin film including three repeating unit layers may be manufactured by stacking a fourth Nb₂O₅ layer 310-4 on a top of the third repeating unit layer. In this instance, a thickness of the fourth Nb₂O₅ layer 310-4 may be 25˜33 nm.

According to an embodiment of the present invention, when applying an Nb₂O₅ layer, the Nb₂O₅ layer is applied using an Nb₂O₅ target, i.e. a ceramic target, instead of using a niobium (Nb) target and a reactive sputtering method, in an argon atmosphere. When using the reactive sputtering, an amount of oxygen and argon (Ar) injected corresponds to approximately 200 sccm: When using the ceramic target, an amount of the argon injected corresponds to approximately 140˜210 sccm. Also, an amount of oxygen injected corresponds to approximately 4˜12%, preferably about 8˜12%, of the amount of the argon. Accordingly, after coating the Ag layer, an electrical conductivity of the Ag layer is not degraded, even when the Nb₂O₅ layer is applied on the Ag layer. Thus, properties of the repeating unit layer does not change even when omitting a barrier layer. Specifically, according to the conventional art, the barrier layer such as an ITO layer or an AZO layer is applied in order to prevent the electrical conductivity of the Ag layer from being degraded due to an oxygen plasma while applying the Nb₂O₅ layer. However, in the present invention, the barrier layer may be omitted. Specifically, four second oxide film layers of the 4-Ag structure shown in FIG. 2 are unnecessary.

An average refractive index of a high refractive transparent thin film layer of the multi-layer thin film according to the present invention is greater than an average refractive index of a high refractive transparent thin film layer according to the conventional art. In this instance, the high refractive transparent thin film layer according to the conventional art has the barrier layer. Accordingly, light transmittance and a light transmittance bandwidth of the high refractive transparent thin film layer according to the present invention are improved.

The PDP filter including three repeating unit layers as shown in FIG. 4 has a sheet resistance of approximately 0.9˜2.5 Ω/sq, preferably about 0.9˜1.1 Ω/sq, and a light transmittance of 75±4%.

FIG. 5 is a diagram illustrating a structure of a multi-layer thin film of a PDP filter having a 4-Ag structure according to another embodiment of the present invention.

Similar to the description of the multi-layer thin film of FIG. 4, a plurality of repeating unit layers is sequentially stacked. In this instance, the repeating unit layer includes a high refractive transparent thin film layer, a metal oxide film layer, and a metal thin film layer. A manufacturing process condition for forming the multi-layer thin film shown in FIG. 5 is identical to the manufacturing condition described above in FIGS. 3 and 4. Also, as shown in FIG. 5, a first repeating unit layer which is the closest to a transparent substrate 210 and a fourth repeating unit layer which is the farthest from the transparent substrate 210 have an identical thickness. A second repeating unit layer and a third repeating unit layer have an identical thickness, which will be described in detail below.

A thickness of a first Nb₂O₅ layer 410-1 included in the first repeating unit layer may be approximately 25˜33 nm, preferably about 27˜33 nm, and a thickness of a first AZO layer 420-1 may be approximately 3˜7 nm. Also, a thickness of a first Ag layer 430-1 may be approximately 10˜12 nm.

A second Nb₂O₅ layer 410-2, a second AZO layer 420-2, and a second Ag layer 430-2 are sequentially stacked. In this instance, a thickness of the second Nb₂O₅ layer 410-2 included in a second repeating unit layer may be approximately 25˜33 nm, preferably about 27˜33 nm, and a thickness of the second AZO layer 420-2 may be approximately 3˜7 nm. Also, a thickness of the second Ag layer 430-2 may be approximately 11˜14 nm.

A thickness of a third Nb₂O₅ layer 410-3 included in a third repeating unit layer may be approximately 25˜33 nm, preferably about 27˜33 nm, and a thickness of a third AZO layer 420-3 may be approximately 3˜7 nm. Also, a thickness of a third Ag layer 430-3 may be approximately 11˜14 nm. Specifically, each layer's thickness of the third repeating unit layer is identical to each respective layer's thickness of the second repeating unit layer.

A thickness of a fourth Nb₂O₅ layer 410-4 may be approximately 25˜33 nm, preferably about 27˜33 nm, and a thickness of a fourth AZO layer 420-4 may be approximately 3˜7 nm. Also, a thickness of a fourth Ag layer 430-4 may be approximately 10˜12 nm. Specifically, each layer's thickness of the fourth repeating unit layer is identical to each respective layer's thickness of the first repeating unit layer.

A PDP filter having the multi-layer thin film including the repeating unit layers may be completed by stacking a fifth Nb₂O₅ layer 410-5 on a top of the fourth repeating unit layer. In this instance, a thickness of the fifth Nb₂O₅ layer 410-5 may be 25˜33 nm.

The PDP filter including the repeating unit layers as shown in FIG. 5 has a sheet resistance of approximately 0.6˜1.2 Ω/sq, preferably about 0.7˜1.1 Ω/sq, and a light transmittance of 67±5%.

In the present invention, a preferable number of the repeating unit layers is 3 to 6 repeating unit layers. Although the multi-layer thin films including three or four repeating unit layers in FIGS. 3 and 4 have been described above, the present invention is not limited thereto. A component layer of a repeating unit layer which is the closest to the transparent substrate 210 and a component layer of the repeating unit layer which is the farthest from the transparent substrate 210 have an identical thickness. Also, respective component layers of all repeating unit layer which are located in the middle of the repeating unit layers have an identical thickness. Depending on a number of the repeating unit layer, physical properties of the PDP filter may vary.

In the present invention, in order to improve a mechanical strength or resilience against an environment of the multi-layer thin film, a hard coating layer may be formed on a surface excluding a surface in which the multi-layer thin film of the transparent substrate is stacked. Also, a predetermined protection layer which does not degrade conductivity and optical characteristics may be formed on a conductive surface. In this instance, the conductive surface refers to a surface where the repeating unit layer is formed on the transparent substrate.

Also, in order to improve resilience against an environment of the metal thin film and an adherence of the metal thin film with the high refractive transparent thin film, a predetermined inorganic material which does not damage the conductivity and the optical characteristic may be included between the metal thin film and the high refractive transparent thin film. The inorganic material may include copper, nickel, chrome, gold, platinum, zinc, zirconium, titan, tungsten, tin, palladium, or an alloy of at least two inorganic materials described above. A preferable thickness of the inorganic material corresponds to 0.02˜2 nm. The adherence may not be improved when the thickness is insufficient. Also, a multi-layer thin film having increased light transmittance may be obtained by forming a reflection prevention layer which is composed of a mono-layer or a multi-layer on a top portion of the multi-layer thin film.

According to the present invention, a conductive film filter which is located on a silver (Ag) thin film and does not suffer degradation in conductivity, and a conductive material of a PDP filter without requiring an additional oxide protection layer is provided.

According to the present invention, a target cost for a deposition of a conventional second oxide film may be reduced without a reduction in conductivity, and retard a degradation process of the conventional second oxide film.

According to the present invention, a PDP filter having a simple-structured multi-layer thin film is provided, and thereby may improve a refractive index and light transmittance of the PDP filter.

According to the present invention, a coating method without requiring a great amount of added oxygen is provided and thereby may increase productivity of a coating facility.

According to the present invention, a PDP filter having a multi-layer thin film which does not require an additional formation of a second oxide film layer according to a conventional art, is provided.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A plasma display panel (PDP) filter having a multi-layer thin film, the PDP filter comprising:
a transparent substrate;
at least one repeating unit layer comprising a high refractive transparent thin film layer, a metal oxide film layer, and a metal thin film layer located on the transparent substrate and stacking each repeating unit layer; and
the high refractive transparent thin film layer being formed on a upper portion of the at least one repeating unit layer.

2. The PDP filter of claim 1, wherein the high refractive transparent thin film layer consists of a niobium pentoxide (Nb₂O₅).

3. The PDP filter of claim 2, wherein the Nb₂O₅ is coated using a target Nb₂Oₓ, where x designates a value from 4.5 to 4.99 in an oxygen atmosphere.

4. The PDP filter of claim 3, wherein the Nb₂O₅ is coated using a target Nb₂Oₓ, where x designates a value from 4.8 to 4.99 in an oxygen atmosphere.

5. The PDP filter of claim 1, wherein the metal thin film layer consists of any one of silver and an alloy consisting of the silver.

6. The PDP filter of claim 1, wherein the metal oxide film layer consists of an aluminum-doped zinc oxide (AZO).

7. The PDP filter of claim 1, wherein a thickness of the high refractive transparent thin film layer is between 25 nm and 33 nm.

8. The PDP filter of claim 7, wherein the thickness of the high refractive transparent thin film layer is between 27 nm and 33 nm.

9. The PDP filter of claim 1, wherein a thickness of the metal oxide film layer is between 10 nm and 12 nm.

10. The PDP filter of claim 1, wherein:
at least two repeating unit layers are provided;
a thickness of the metal thin film layer which is the closest to the transparent substrate and the metal thin film layer which is the farthest from the transparent substrate, from the repeating unit layer, is between 10 nm and 12 nm; and
a thickness of a metal thin film layer included in the repeating unit layer excluding the repeating unit layers including the metal thin film layers which is the closest to and the farthest from the transparent substrate is between 11 nm and 14 nm.

11. The PDP filter of claim 1, wherein three repeating unit layers are provided, and the multi-layer thin film has a sheet resistance between 0.9 Ω/sq and 2.5 Ω/sq, and a light transmittance between 71% and 79%.

12. The PDP filter of claim 11, wherein the multi-layer thin film has a sheet resistance between 0.9 Ω/sq and 1.1 Ω/sq.

13. The PDP filter of claim 1, wherein four repeating unit layers are provided, and the multi-layer thin film has a sheet resistance between 0.6 Ω/sq and 1.2 Ω/sq, and a light transmittance between 62% and 72%.

14. The PDP filter of claim 13, wherein the multi-layer thin film has a sheet resistance between 0.7 Ω/sq and 1.1 Ω/sq, and a light transmittance between 63% and 71%.

15. A method of manufacturing a PDP filter, the method comprising:
stacking at least one repeating unit layer comprising a high refractive transparent thin film layer, a metal oxide film layer, and a metal thin film layer on a transparent substrate; and
stacking the high refractive transparent thin film layer on a upper portion of the at least one repeating unit layer.

16. The method of claim 15, wherein the high refractive transparent thin film layer consists of Nb₂O₅.

17. The method of claim 16, wherein the Nb₂O₅ is coated using a target Nb₂Oₓ, where x designates a value from 4.5 to 4.99 in an oxygen atmosphere.

18. The method of claim 15, wherein the metal thin film layer consists of any one of silver and an alloy consisting of the silver.

19. The method of claim 15, wherein the metal oxide film layer consists of an AZO.
